(19) United States
(12) Patent Application Publication
(10) Pub. No.: US 2024/0017730 A1
(43) Pub. Date: Jan. 18, 2024

(54) CHILD MONITORING SYSTEM INSIDE A CAR

(71) Applicants: Evelyn Shen, Palo Alto, CA (US); Crystal Jing Li, Palo Alto, CA (US)

(72) Inventors: Evelyn Shen, Palo Alto, CA (US); Crystal Jing Li, Palo Alto, CA (US)

(21) Appl. No.: 17/812,051

(22) Filed: Jul. 12, 2022

(51) Int. Cl. B60W 50/00; B60R 1/29; B60H 1/00; B60R 16/033; E05B 81/56; E05F 15/71; E05F 15/72; E05F 15/73; G08B 21/22; G08B 21/18

(52) U.S. Cl. CPC B60W 50/0098; B60R 1/29; B60H 1/00742; B60H 1/008; B60H 1/00778; B60R 16/033; E05B 81/56; E05F 15/71; E05F 15/72; E05F 15/73; G08B 21/22; G08B 21/182; B60R 2300/8013; B60W 2420/42; B60W 2420/54; B60W 2540/043; E05F 2015/765; E05F 2015/763; E05Y 2400/44; E05Y 2400/52; E05Y 2800/252; E05Y 2900/55

(57) ABSTRACT

A system monitors a child accidentally left in a car, comprising a microprocessor, a plurality of sensing device including optical image sensors, Infrared sensors, sounds sensors, motion sensors, and weight sensors. The system automatically turns on and connects to the car battery when the car is turned off. When the system detects a child or a pet is left in the car, it will monitor temperatures inside the car. The system detects whether the temperature inside the car changes quickly, above or below a threshold, before taking actions to protect the child. Such actions include lowering the windows, unlocking the doors, or turning on the air conditioning system to maintain the temperature inside the car. The system will send out warning signals to a connected smart phone to alert the parents of the child. The system will also send such signals to a nearby police or an emergency service.

### TECHNICAL FIELD OF THE INVENTION

The described embodiments relate generally to a monitoring system to monitor a child left alone inside a car and the associated methods. More particularly, the described embodiments relate to using a plurality of sensors, including optical image sensors, infrared sensors, sounds sensors, motion sensors, weight sensors, to detect whether a child is left alone in the car; monitoring and monitoring the temperature inside the car, so that the child would not get a heat stroke in a hot summer day or hypothermia in a cold winter day.

### BACKGROUND

Every year there are about many babies accidentally left alone in cars, while their parents went on their business, e.g., shopping. On average fifty babies died from heat strokes in summertime each year. These tragedies are often results of accidents, which, in the medical field, it is known to be the “Forgotten Child Syndrome” or FBS. Researches show FBS can happen to any parents. People left their babies in cars not because they care less about their babies or because they are negligent parents, but the neurobiology behind FBS. People perform tasks as routines, which do not involve much thinking or decision-making. This is controlled by a part of brain called motor vertex, such as stopping at a stop sign. There are other cognitive parts in the brain involved in decision-making. Something could happen to interrupt this routine, after which, the motor vertex part of the brain will override the decision-making part and parents would completely forgot they have a child in the car.

The National Highway Transportation Safety Administration, a government agency belonging to the Department of Transportation of the United States government, warns that a child's body temperature can rise three to five times faster than that of adults. A temperature inside a car, sitting directly under the sun, can rise more than 20 degrees within 10 minutes. A child's body starts to have heat strokes when his or her body temperature gets to 104 degree and all organs would fail when the body temperature is over 107 degrees and the child could die within minutes. The Agency recommends never leaving a child in a car when the outside temperature is above 92 degrees.

Unfortunately, the medical condition of FBS will surely result in forgotten babies inside cars, no matter how careful the parents are and whatever tactics the parents would use to prevent it from happening.

Each year, there are also pets like dogs and cats being left in cars, suffered heat strokes and died. People are more willing to leave pets inside cars, because some places like restaurants, do not allow pets. This is getting worse over the years so that one of the humane societies declared a national crisis, despite about half of the states implemented pets in hot car laws, such as the Right to Rescue Act in California, in order to save lives and shield any rescuers of these pets from potential liabilities to the car owners.

Thus, another way to monitor the babies or pets inside a car and to prevent the tragedies from happening, is in the urgent need. Tesla has attempted to solve the problem by adding a feature of all Tesla electric cars, the Dog Mode. According to Tesla, the way it works is for driver to set a temperature inside the car, more or less the same as in setting a temperature on a thermostat in a house, so that even though the driver is not there the air conditioning is always on to maintain the temperature inside the car. A message will display on its center screen to let other people know that the dog is safe inside the car. The Dog Mode will turn on when the driver leaves and turn off when the driver comes back. Tesla is an electric car and the AC is directly tied to large battery underneath the car and can be turned on without starting the engine. The Dog Mode, however, will quickly drain the battery so that a prolonged time will not only endanger the dog but also get the car stranded for lack of battery. Further, even in a comfortable condition a child can still be distressed and require immediate attention. A more advanced system is needed to satisfy that needs.

### SUMMARY OF THE INVENTION

Embodiments of the systems, devices, and methods, described in the present disclosure are directed to methods of using a monitoring system to monitor a child being left in a car. The monitoring system comprises a microprocessor, a plurality of sensors to monitor the child inside the car. The monitoring system will connect to and control, through wired or wireless connections, several sensors, including at least an Infrared sensor, a motion sensor, a sound sensor, a weight sensor, an optical image sensor, or any combination of these sensors. These sensors will detect various characteristics associated with a living creature, e.g., a child, a pet, etc., such as a body temperature of the child, noise made, motion of the child, etc. These signals are fed into the microprocessor, which uses artificial intelligence to determine whether a child is left inside the car; and start monitoring a temperature inside the car and the body temperature of the child. When either the temperature inside the car or the child body temperature rises quickly during a summer day or drops quickly during a winter day, the monitoring system will turn on the AC system in the car to maintain temperature. During summertime, the monitoring system can also take control of the car driving system to slowly roll the car into a nearby shaded area, lower the windows of the car to cool, and unlock the doors to facilitate a rescuer.

In one aspect, the system can also utilize a chemical sensor to monitor the carbon diode level inside the car. Carbon dioxide breathed out by the child can be toxic if accumulated to a certain level in a closed environment. Once the carbon dioxide level is higher than a certain level, the monitoring system can also perform the tasks as in the temperature case to preserve life.

In another aspect, the monitoring system is also connected to the car communication unit. The microprocessor will demand the communication unit to send a warning message to a connected phone in the unit, e.g., the owner's smart phone, so that the owner will get an instant warning of the child being left in the car. Such a message can be sent out by the communication unit through WiFi, Bluetooth, RF signal through cellphone services, or other suitable technologies. In cases the owner cannot come back in time or cannot be reached immediately, the communication unit may also connect to an emergency service such as 911. The monitoring system can also set off the car alarm, often with high pitch sounds and flashing lights, to alert nearby pedestrians or even nearby police.

In another aspect, the monitoring system is connected to the car battery or connected to its own battery. It is shut off to preserve battery when the car is started and only turned on when the engine is off and the door is locked. If the monitoring systems determines no child is inside the car, the monitoring system will shut down after its initial assessment. It is constantly on only during the mode when a child is left alone in the car, which requires monitoring the temperatures, or during the mode the monitoring system will control the car to start the AC, operating the windows, the doors, or even rolling the car.

In yet another aspect, the optical image sensors equipped in the monitoring system will be installed near or at the ceiling of the car, unlike a regular driver monitor system, so that a scope of its views will include the backseat, where normally a child seat is installed, not to be blocked by the high rise of the seats in front row.

The image sensors may include a system-on-chip (SOC) to control the image sensor and the camera to process, enhance, compress image, and save output images to a flash drive. Based on real time image analysis, the SOC may provide control of the image sensor and the LEDs to adjust exposure time control, auto-gain control, and auto white balance; to adjust the image sensor frame rate or the operating mode. The SOC may also process zone average of an image and save a time-stamped image only if an image is different from a previous captured image. Machine learning algorithm may also be used to analyze captured images and to identify images with critical feature, such as incorporating time stamps on images.

In another aspect of the present disclosure, a weight sensor can be installed in the child seat or the back seat so that the weight difference will help the microprocessor to determine the existence of the child in the car without the presence of the driver.

In another aspect of the present disclosure, a method of monitoring a child left alone in a car is disclosed as providing a monitoring system including a microprocessor, a plurality of sensors, a switching unit, and a communication unit; connecting the monitoring system with a control system of the car; detecting the child in the car; monitoring a temperature and/or carbon dioxide concentration in the car; switching on the control system of the car when the temperature is above a threshold value or the carbon dioxide concentration in the car is above a threshold value; communicating to a smart device to alert an owner of the car; and alarming an emergency service or pedestrians nearby.

In addition to the exemplary aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a schematic of a child seat.

FIG. 2 schematic of the child monitoring system in the present disclosure.

FIG. 3 shows different modes of alarm produced by the monitoring system.

FIG. 4 shows a method of the using the monitoring system.

### DETAILED DESCRIPTION

Reference will now be made in detail to representative embodiments illustrated in the accompanying drawings. It should be understood that the following description is not intended to limit the embodiments to one preferred embodiment. To the contrary, it is intended to cover alternatives, modifications, and equivalents as may be included within the spirit and scope of the described embodiments as defined by the appended claim. References are made to by ways of examples and this is by no means limiting and a person with ordinary skills in the art may appreciate that a similar method in the invention may be used as well.

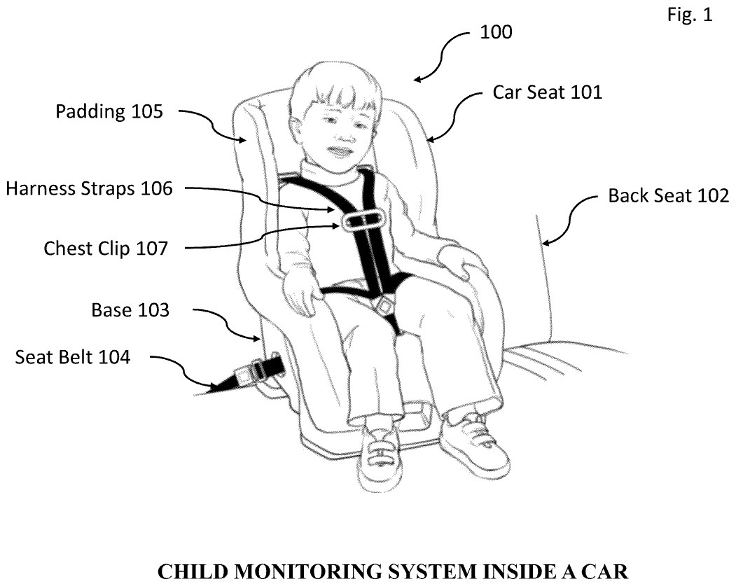

Reference is now made to FIG. 1, which illustrates a schematic of a typical child seat. A car seat 101 is installed on a back seat 102 in a typical car, with the base 103 of the car seat 101 abutting the back seat 102, and the base 103 of the car seat 101 is fully secured by a harness (not shown) to the car. The base 103 itself is usually strapped by a seat belt 104 on the back seat 102. It is recommended a child of age 2-4 must sit in a car seat. Children younger than this age range are typically secured in a carrier and in a backward facing position in cars. Older children can sit in a booster seat, which is a simplified version of a car seat. With respect to the car seat 101 shown in FIG. 1, the young child is strapped by harness straps 106 equipped by the car seat manufacturer. Although not required by federal or state laws, most car seats manufactured today are equipped with a chest clip 107, which is to adjust the position of the harness straps 106 so that the harness straps 106 can properly go over the shoulder of the child for the better protection of the child during a crash.

As seen in the illustration in FIG. 1, a young age child (2-4 years old), once settled in the car seat 101, will be fully strapped down in the car seat 101. If the child is left alone in the car, there is no possibility the child can escape the car seat, either due to his or her young age, or due to the design of the harness straps 106 of the car seat 101. The design of the car seat will fully protect the child during a crush, but unfortunately the child can be stranded in the car seat 101 during other abnormal situations.

Unlike a booster seat, a car seat 101 for a young age child is often designed with heavy padding 105, which are made of thick plastic foams, to provide the best comfort for the young child and the best cushion during a car crash. Such thick foam and the design of the padding 105 is to ensure the snugly fit of the child into the car seat 101, so that during a car crash lateral movement of the child can be minimized to reduce possibilities of injury. Unfortunately, such thick foam will also prevent a dissipation of heat spreading from the body of the child. This will exacerbate the problem if the child is left alone in a closed car if the outside temperature is either too hot or too cold.

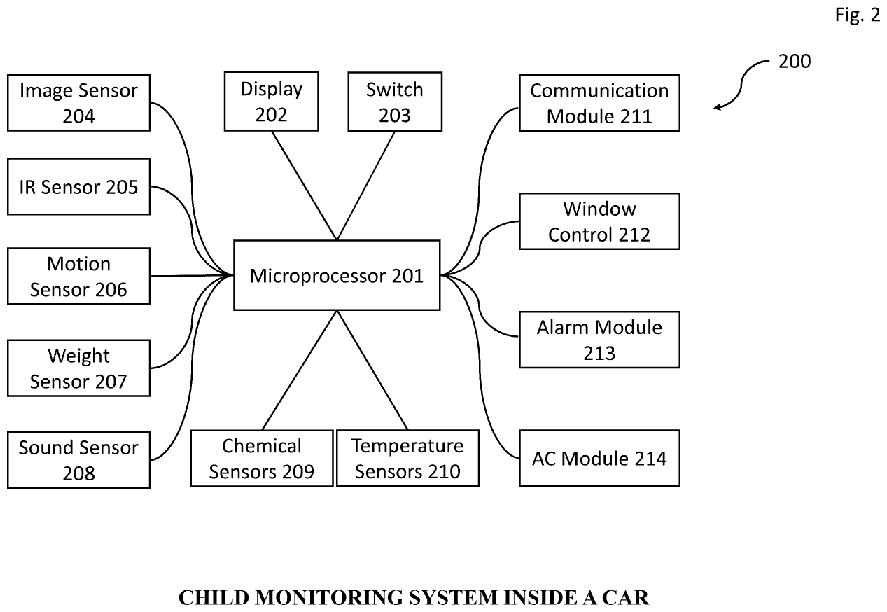

Reference is now made to FIG. 2, which illustrates a schematic view of the child monitoring system 200 in the present disclosure. The monitoring system 200 comprises of a microprocessor 201, which processes signals from various periphery sensors installed in the car. The microprocessor 201 can be either a central processing unit (CPU), such as those from Intel and AMD, a graphic processing unit (GPU), such as those from AMD and nVidia, or a field-programmable gate array (FPGA), such as those from Xilinx. The microprocessor 201 is often equipped with sufficient memory such as dynamic random access memory (DRAM) or high bandwidth memory (HBM) for faster processing speed. The microprocessor 201 may be also equipped with storages such as NAND devices to store data in the microprocessor 201 for a diagnostic, data protection, or analytic use. The microprocessor 201 is connected to the periphery sensors by wired or wireless connections so that the data collected through the sensors will be processed through the microprocessor 201. The microprocessor 201 is either powered by the same car battery or equipped with its own separate battery pack.

A display 202, such as a light emitting diode (LED) display, is optionally attached to the microprocessor 201 so that a person may look up necessary information in order to understand the status inside the car. For example, a temperature reading may be shown on the display 202. A flash warning sign may also be shown on the display 202 so that bypassing police or a pedestrian may notice an emergency situation inside the car.

A switch 203 is installed in the monitoring system 200. An important function of this switch 203 is to ensure the monitoring system 200 will not turn on in certain scenarios. For example, the monitoring system 200 is turned off when a driver, e.g., the parent, is in the car and driving. The switch 203 will sense when the car is parked and the door is locked, in which case the driver is outside the car, before turning on the monitoring system 200. The switch 203 can also be controlled with a keyless entry fob, which are often used to lock and unlock doors in at least modern cars.

Modern cars are often equipped with cameras for various reasons, for driving assistance, parking, backing up, or for driver monitoring inside a car. For the child monitoring system 204 as in the present disclosure to work, the camera must be installed inside a car and at a position high enough, such as at a level of a back up mirror, so that a child in the car seat at the back of the car is in the purview of the camera. The camera has an optical sensor 204 for take images from the child. Such an optical sensor 204 may be a charge-couple device (CCD) or a complimentary metal oxide semiconductor (CMOS) based device, which are manufactured with photodiodes. Lights reflected by the child will be taken by the image sensor 204 and photo currents are generated by the photodiodes, which through digital processing by a logic circuit in the image sensor 204 itself, or a separate logic circuit connected to the image sensor 204, an image of the child will be generated. The image will be fed into the microprocessor 201 for the determination whether a child or a pet is left in the car, through machine learning or artificial intelligence. Unlike a child being confined in the car seat, a pet left alone in the car is often unrestrained and can move around inside the car. Incremental optical images can detect the positions of the pet inside car, relative to the surroundings, and direct other sensors to focus onto the pet.

The child monitoring system 200 will also comprise an Infrared sensor (IR) sensor 205. Instead of an optical image from the image sensor 204, an IR sensor 205 receives a heat radiation from the child and detects a thermal signature of the child or a pet in the backseat of the car. This is complementary to the optical image and particularly useful in a low light situation. One particular type of the IR sensor 205 may be a thermal IR sensor, which will detect and determine the temperature of an object. Once the child is located by optical imaging or other ways as described later, the microprocessor 201 can direct the IR sensor 205 to monitor the body temperature of the child. It is particularly useful to get a direct temperature response from the monitored child instead of the ambient to determine the change of the child's body temperature in response to the actions taken by the microprocessor 201 (described later), and whether the situation must be escalated. An IR sensor 205 is also useful in when a small baby is in a carrier facing backwards in the back seat, where the view of the image sensor 204 will be blocked by the carrier.

The child monitoring system 200 as in the present disclosure may also include a motion sensor 206 to detect any movement of the child, e.g., face movement of the child. This is one way to complement the optical image sensor 204 and IR sensor 205 for a better determination of whether a child or a pet is left alone in the car. Or, the facial detection of the child will also help determine if the child is in distress, for example, if the whether is too hot or too cold.

Similarly, a weight sensor 207 may be installed in the car seat or the back seat of the car. The weight sensor 207 can detect a weight difference before and after the child is settled in the car seat. This is useful in a number of ways. One is to complement the optical image sensor 204 or other ways to determine whether a child is left alone in the car. For example, a child of two to four years old may weigh 30-60 pounds. A current generated by the pressure on the weight sensor 207, is different with or without the child. The output signal of the weight difference can also be used to feed the switch 203 to turn on the child monitoring system 200. The weight sensor 207 can sense the pressure by weight put on the sensor surface.

The child monitoring system 200 can be further improved by incorporating a sound sensor 208. The sound sensor 208 is often a diaphragm, which is sensitive to a pressure change by a sound wave it receives. This sound sensor 208 will help the determination of the child or pet left alone in the car. In certain situations, the sound sensor 208 will also detect the child in distress, e.g., the child crying due to uncomfortable conditions so that the microprocessor will decide how to escalate the response to the situation.

When the car is parked, the ventilation of the cabin air is at its worst. Breadth of the child or a pet will cause the carbon dioxide concentration to rise quickly. Researches show carbon dioxide level can quadruple within 5 minutes and reach a level of six times higher within 20 minutes, even with the ventilation is open. Carbon dioxide can cause drowsiness and slow cognitive reactions to human beings, or even deaths. Each year police there are reported 15-20 deaths of police K9 due to high carbon dioxide concentrations in police cars. The fabrics and decoration materials used inside cars will also emit other toxic chemicals, along with carbon dioxide, if the car is directly exposed under the sun. It is necessary to incorporate a chemical sensor 209, to detect the carbon dioxide levels in the car. Once the carbon dioxide level reaches a certain level, i.e., a few thousand parts per million, the output signal of the chemical sensor 209 will be fed into the microprocessor 201, which in turn will control the ventilation system of the car in order to bring the carbon dioxide level down. This can be done regardless of the temperature inside the car for further protection of the left-alone child or the pet.

One key aspect of this present disclosure is to measure temperature inside a car to prevent a left-alone child or a pet to undergo a heat stroke or a hypothermia. In order to do that, temperature sensors 210 are the must-to-haves. Temperatures sensors 210 as simple as a thermocouple type or as sophisticated as semiconductor thermal sensors can be installed around the cabin of the car, surrounding the back seat where the car seat would normally be installed. A plurality of temperature sensors 210 must be used to eliminate errors. For example, a temperature 210 installed close to a window may cause the temperature sensor to be exposed directly under the sun and reading from the temperature sensor 210 may not accurately reflect the actual temperature inside the car. An average of the temperature readings is needed from temperature sensors 210 at various locations of the cabin to better reflect the actual temperature as well as eliminate the possibility of a faulty sensor. The temperature sensors 210 can output voltages or currents or actual digital signals according to a calibrated curve to determine the temperature. Such a voltages or currents or signals will be fed into the microprocessor 201 so that the microprocessor 201 makes a decision to take actions based on the situation. There can be two ways the output signals from the temperature sensors can be utilized. One way is to monitor the actual temperature with a pre-set threshold value, such as 85 F for a high threshold, or 65 F for a low value, for example. If the temperature measured outside this range, the microprocessor 201 will initial actions such as lowering the window, turning on the AC, turning on the heater, etc. Another way is to calculate a rate of change of the temperature to take actions if the rate of change is too high. For example, based on the rate of change of the cabin temperature, the microprocessor 201 will decide to trigger one or more protective measures as described above. If the temperature change is reversed quickly or a rate of temperature change is too slow, as determined by the temperatures sensors 210 and the microprocessor 201, the microprocessors 201 can decide to take even more aggressive measures such as increasing the ventilation rate, or even rolling the car automatically into a shaded area if necessary. The temperature sensors 210 and the IR sensor 205 can work in tandem to see whether the child is in danger, with comparison with the cabin temperature, so that the microprocessor 201 will determine the effectiveness of the measures taken and determine whether further measures must be taken in order to protect the child or the pet inside the car.

All these abovementioned sensors are attached to child monitoring system 200 for the purposes of determining if there is a child or a pet being left in the car alone; and if so, whether the ambient in the car is harmful to the child. These are performed by various sensors as disclosed previously to providing inputs to the microprocessor 201, which makes decisions based on these inputs. Once the decision is made, however, the microprocessor 201, connected also to the main control system of the car, will need to trigger different measures by controlling the devices in the car through the control system of the car, to mitigate the harmful situation for the child or the pet.

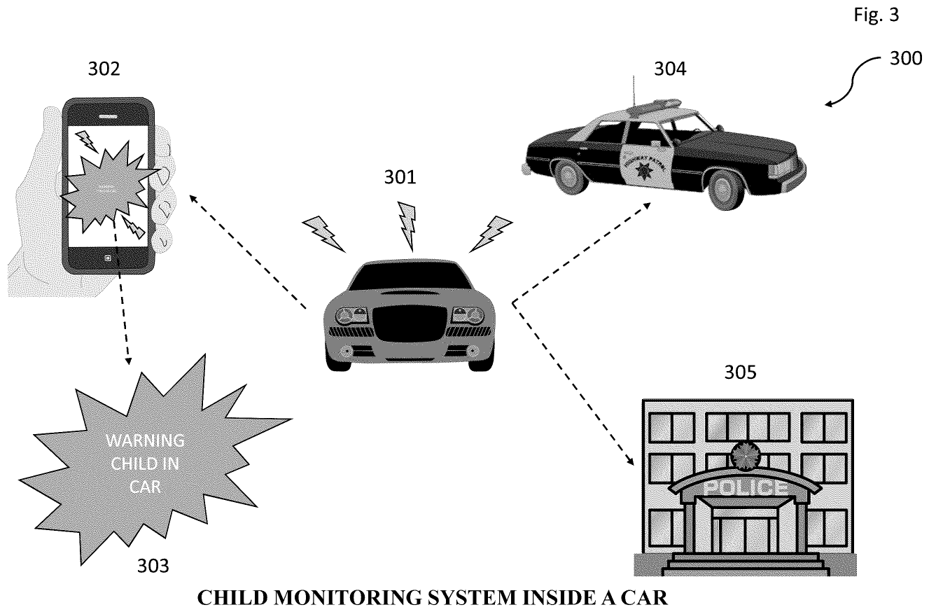

One of the modules the microprocessor 201 needs to connect and control is the communication module 211. Modem cars are often equipped with Bluetooth, WiFi, cell phone connections, or even cloud connections to control and operate the car. In emergency situations such as a child stranded in the car about to have a heat stroke, the microprocessor 201 will generate message, such an SMS message, and send the message, a picture, or a video to a connected cell phone (most likely the car owner's phone), as shown in FIG. 3 (302 and 303), to alert and remind the car owner of the forgotten child in the car and the dire situation the child is going through. In addition, the microprocessor 201 can send a similar message or alert to nearby emergency services such as the 911 service (FIG. 3, 305) so that the police will know the location and situation of the left-alone child and can dispatch medical help immediately to rescue the child or pet.

In addition to connecting and controlling the communication module 211, the child monitoring system 200 or the microprocessor 201 is also connected to the windows control 212 and AC control 214 of the car. As described previously, in a situation the cabin temperature is rising above a certain threshold value or the rate of the temperature rising is significant, the microprocessor 201 will send a command to the main operating system of the car to turn on the AC, lower the windows, or both, in order to bring down the temperature. In a cold situation the microprocessor 201 will send a command to the main operating system of the car to turn on the heater of the car, in order to increase the temperature inside cabin. By connecting to the main operating system of the car, the microprocessor 201 may even send a command to slowly roll the car into a nearby shaded area, if any.

The child monitoring system 200 and the microprocessor 201 is also connected to the car alarm system 213. Most car alarm system today will generate loud sounds, combined with flashing lights, as shown in FIG. 3 (301), to scare possible intruders away. Some alarm systems are automatically connected to an emergency service or a private security monitoring service. By activating the car alarm, the flashing lights and the loud sound can attract nearby pedestrians or even a nearby police (FIG. 3, 304) to come to the rescue. By lowering the windows and unlocking the doors through such control by the microprocessor 201, a breaking-in of the windows or the doors of the car can be minimized to reduce property damage while rescuing the endangered child.

All the protective measures taken by the child monitoring system 200 are meant for a short period of time. Taking these measures for a prolonged time will drain a car battery, even in an electric car, and should be avoided. Most abovementioned sensors should be low powered and operated in pulse modes to save battery life. An extra battery may be needed just for the child monitoring system 200 itself. These protective measures can be turned on one at a time or all at once, depending on the situation and also optimized on a balance of battery life and performance of these measures.

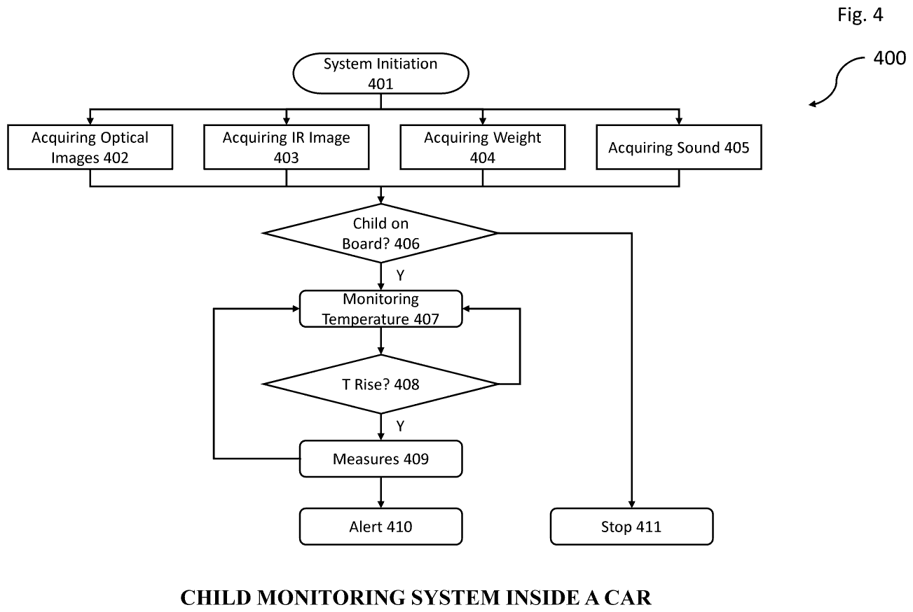

Reference is now made to FIG. 4, which illustrates a process flow of using the child monitoring system 200 in the present disclosure. For simplification of the discussion, the process flow only illustrates a child being left alone in the car and only in a temperature rise situation. A person with ordinary skill in the art will understand that the same process can also be applied to a pet being left in the car or during a temperature decrease situation, even though the protective measure taken by the child monitoring system 200 may be different. On the same token, the same process can also be used for monitoring the carbon dioxide concentration in the carbon and the child monitoring system 200 can cause the car control system to take the same protective measures such as lowering the windows and turning on the ventilation system (or AC) to reduce the carbon dioxide concentration in the cabin. Again for the simplification purpose the disclosure will focus only on the temperature control.

When the car is stopped, parked, or the door is locked, the child monitoring system 200 is activated (401) by enabling various sensors designed for the child monitoring system 200. For example, a weight sensor or a sound sensor is often passive, meaning they sense a difference in weight or pressure. The other sensors such as the IR sensor or the optical image sensor can be used by focusing on the child seat or scanning the back seat. The input signals from these sensors (402-405) will be fed into the microprocessor, which will use machine learning and artificial intelligence to determine whether a child is being left alone in the car. If there is no child or pet left in the car, the child monitoring system 200 shuts down automatically to save battery life (411).

If the child is alone in the car, the child monitoring system 200 will take an initial temperature of the child using an IR sensor and using other temperature sensors to measure the cabin temperature (407). The temperatures of the cabin amongst sensors at different locations can be averaged out to reflect a more accurate cabin temperature. The child monitoring system 200 takes temperatures readings from the child and the surrounding air in the cabin, either continuously or at a time interval. By comparing a first temperature reading and a subsequent reading of the child body temperature or the cabin temperature, a rate of rise of the body or cabin temperature can be calculated (408). The microprocessor 201 can have a pre-set threshold temperature, e.g., 85 F, above which the child may be at an endangered condition. Once the temperature rise rate is determined, the microprocessor 201 can extrapolate the readings to calculate a time period when the cabin temperature will cross the threshold value.

If the cabin temperature is determined not rising, the child monitoring system 200 will continue monitoring the temperatures without taking any protective measures. However, if the temperature rises above the threshold value, the child monitoring system 200 will activate the main control system of the car with a keyless fob to control a number of sub-systems in the car (409). These can include lowering the windows, unlocking the car, turning on the AC, or in the temperature decrease situation, turning on the heater to avoid hypothermia of the child.

Once these measures are in place, the child monitoring system 200 will continue to take temperature readings from the child and the cabin. The same rate calculation or threshold determination will be carried out continuously by the child monitoring system. Once the temperature is below the pre-set threshold value, the child monitoring system 200 will cause the control system of the car to continue to run for a certain time, e.g., 1 more minute, before shutting down the sub-systems such as the AC system, in order to save battery life. Other measures not actively using battery power, such as the windows, can be kept in their lowered positions in order to prevent the temperature to rise again.

Simultaneously, the child monitoring system 200 will also generate a warning, sent through the car communication module by Bluetooth, WiFi, RF, SMS, cloud service, or other suitable methods to a connected smart phone to warn the owner or the patents about the left-alone child. The warning can be text based, picture of the child in distress, or a short video of the child inside the car. The same warning messages can also be sent by the same technologies to a connected car service like the OnStar system by General Motors or an emergency service like the 911 service to alert the police so that rescue workers can be dispatched immediately for the child.

The child monitoring system can also activate the car alarm to flash lights and making a loud noise to alert nearby pedestrians or even police to the rescue.

What is claimed is:

1. A method of monitoring a child left alone in a car, comprising:
providing a monitoring system including a microprocessor, a plurality of sensors, a switching unit, and a communication unit;
connecting the monitoring system with a control system of the car;
detecting the child in the car;
monitoring a temperature in the car;
monitoring a carbon dioxide concentration in the car;
switching on the control system of the car when the temperature is above a threshold value or the carbon dioxide concentration in the car is above a threshold value;
communicating to a smart device to alert an owner of the car;
alarming an emergency service or pedestrians nearby;
wherein the switching on the control system includes starting a temperature control in the car, controlling windows of the car, and unlocking doors of the car.

2. The method in claim 1, wherein the plurality of sensors includes at least an optical image sensor, an infrared sensor, a weight sensor, a motion sensor, or a sound sensor.

3. The method in claim 2, further comprising a chemical sensor to monitor the carbon dioxide concentration in the car.

4. The method in claim 2, further comprising a plurality of temperature sensors to monitor the temperature in the car.

5. The method in claim 1, wherein the monitoring system switched on when the car is stopped.

6. The method in claim 5, wherein the monitoring system is connected to a battery of the car.

7. The method in claim 1, further comprising slowly rolling the car into a shaded area.

8. The method in claim 1, further comprising turning on a heater when the temperature inside the car is below a threshold value.

9. The method in claim 1, further comprising turning off the control system of the car once the temperature or the carbon dioxide concentration is below the threshold value.

10. The method in claim 1, further comprising determining a rate of change of the temperature inside the car.

11. The method in claim 1, wherein the controlling of the windows includes lowering the windows at least to a certain extent.

12. The method in claim 1, further comprising setting off an alarm of the car.

13. The method in claim 1, wherein the communicating with the smart device is by WiFi, Bluetooth, or by radio frequency.

14. The method in claim 1, further comprising sensing a body temperature of the child using the Infrared sensor.

15. An in-car child monitoring system, comprising:
a microprocessor;
a plurality of sensors;
a plurality of temperature sensors;
a switching unit connected to the monitoring system, a control system of the car, wherein the monitoring system powers on when the car is stopped;
a communication unit to transmit messages or pictures between the monitoring system and a smart device; and
wired or wireless connections among the microprocessor, the plurality of sensors, the plurality of the temperature sensors, and the switching unit.

16. The monitoring system in claim 15, wherein the plurality of sensors includes at least an optical image sensor, an infrared sensor, a weight sensor, a motion sensor, or a sound sensor.

17. The monitoring system in claim 16, wherein the optical image sensor is a CMOS based image sensor.

18. The monitoring system in claim 15, further comprising a chemical sensor to monitor carbon dioxide concentration in the car.

19. The monitoring system in claim 15, wherein the communication unit include a WiFi unit, a Bluetooth Unit, or a radio frequency transmission unit.

20. The monitoring system in claim 15, further comprising a display inside the car.
